(19) United States
(12) Patent Application Publication
(10) Pub. No.: US 2020/0070848 A1
(43) Pub. Date: Mar. 5, 2020

(54) Method and System for Initiating Autonomous Drive of a Vehicle

(71) Applicant: Arm Limited, Cambridge (GB)

(72) Inventor: Emre Ozer, Buckden (GB)

(21) Appl. No.: 16/118,277

(22) Filed: Aug. 30, 2018

(51) Int. Cl. B60W 50/08; B60W 40/08; B60W 40/02; B60W 30/10

(52) U.S. Cl. CPC B60W 50/082; B60W 40/08; G05D 1/0088; B60W 30/10; B60W 40/02

(57) ABSTRACT

The present techniques generally relate to a computer implemented method of initiating autonomous drive of a vehicle when the drive of the vehicle is under the control of a user, the method comprising: detecting or predicting the start of a user sneezing episode; and initiating autonomous drive of the vehicle during the user sneezing episode. The method may additionally involve, after the initiating the autonomous drive of the vehicle, determining the end of the user sneezing episode, ending the autonomous drive of the vehicle and reverting the drive of the vehicle back to the control of the user. All of this may be done without the user of the vehicle being aware of the autonomous drive of the vehicle.

The present techniques generally relate to smart vehicles with autonomous control functions. More particularly, the techniques relate to safety features in such vehicles using a computer implemented method and system of initiating autonomous drive of a vehicle when the vehicle is under the control of a user, the method including detecting or predicting when the user of the vehicle is in a sneezing episode.

‘Smart vehicles’ with autonomous drive control are being developed as the next generation of vehicles, particularly as driverless road vehicles. Vehicles with autonomous drive function will be networked and equipped with a large number of sensors to relay information to and from management and supervising systems. Information can be utilised to control autonomously driven vehicles, based on variables such as surroundings, hazards, user input and the weather. Cloud computing services and the “Internet of Things” are becoming part of the management systems of autonomous vehicles.

Varying degrees of vehicle autonomy can be imagined, control does not have to be complete; full or partial control may be beneficial in different situations. For example, autonomous control during times when the user's safety is in question can be an advantage of such systems.

Sneezing is a reflex that causes one to blow air from the lungs for a very short duration, usually occurring simultaneously with the person closing their eyes and bending their head up or down with jerky arm and leg muscles before, during and/or after the sneeze (a sneezing episode). Sneezing whilst using a vehicle may make the driver lose control of the control of the vehicle, e.g. the steering wheel and pedals. This can be a hazardous situation, especially if the vehicle is travelling at high speeds. There are studies correlating traffic accidents to sneezing. For example, one study reported that more than two million drivers have crashed because they have sneezed behind the wheel. Another study shows that drivers can travel up to 15 meters with their eyes closed during a sneeze. Therefore, there is a need for safety features to be added to vehicles to improve safety of vehicle users and surroundings, and there is the potential to utilise the power of autonomous drive control to do this.

According to a first technique, there is provided a computer implemented method of initiating autonomous drive of a vehicle when the drive of the vehicle is under the control of a user, the method comprising: detecting or predicting the start of a user sneezing episode and initiating autonomous drive of the vehicle during the user sneezing episode. In some embodiments, after the initiating the autonomous drive of the vehicle, the method then includes determining the end of the user sneezing episode, ending the autonomous drive of the vehicle and reverting the drive of the vehicle back to the control of the user.

In some embodiments, the ending of the autonomous drive and reverting the drive of the vehicle back to the control of the user is done without the user of the vehicle being aware that there was autonomous drive of the vehicle. The user of the vehicle may be unaware of the autonomous drive of the vehicle. In some embodiments, the user may be unaware of only the initiation of the autonomous drive of the vehicle. In some embodiments, the user may be unaware of both the initiation and the end of the autonomous drive of the vehicle.

According to a further technique, there is provided a system of initiating autonomous drive of a vehicle when the vehicle is under the control of a user, the system comprising: a decision logic module for detecting or predicting the start of a user sneezing episode; and a vehicle control unit for initiating autonomous drive of the vehicle during the user sneezing episode. In some embodiments, the system further comprises a determination unit for determining the end of the user sneezing episode and an ending unit for ending the autonomous drive of the vehicle and reverting the drive of the vehicle back to the control of the user.

According to a further technique, there is provided a computer program comprising a computer-readable storage medium storing computer program code operable, when loaded onto a computer and executed thereon, to cause said computer to control a method of initiating autonomous drive comprising: detecting or predicting the start of a user sneezing episode and initiating autonomous drive of the vehicle during the user sneezing episode. In some embodiments, the computer program also comprises code for determining the end of the user sneezing episode and ending the autonomous drive and reverting the drive of the vehicle back to the control of the user.

According to a further technique, there is provided a vehicle comprising electronic computer apparatus for initiating a method of autonomous drive when the vehicle is under the control of a user, the apparatus comprising a decision logic module for detecting or predicting the start of a user sneezing episode and a vehicle control circuit for initiating autonomous drive of the vehicle during the user sneezing. In some embodiments, the vehicle also comprises apparatus comprising determination logic for determining the end of the user sneezing episode; and ending logic for ending the autonomous drive of the vehicle and reverting the drive of the vehicle back to the control of the user.

The present techniques offer the advantage of improving vehicle drive safety, by allowing the detection or prediction of the user of the vehicle being in a sneezing episode and utilising autonomous drive to take over control of a vehicle when the user may be unable to safely control the vehicle.

The present techniques will now be described with reference to the accompanying figures, of which:

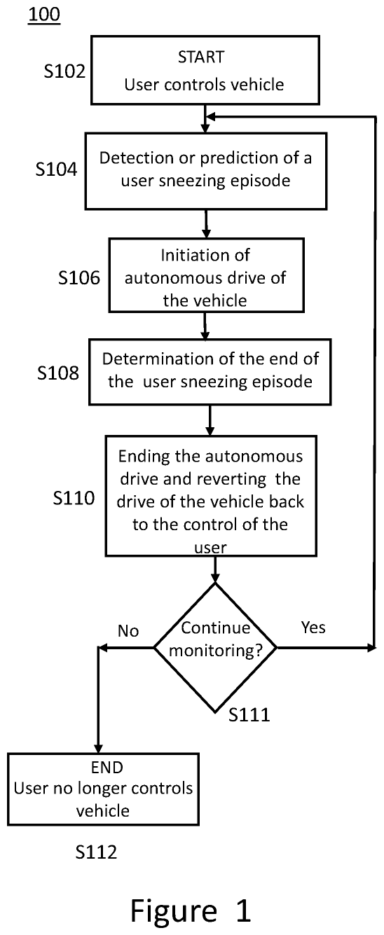

FIG. 1 illustratively shows a simplified flow diagram of a method for initiating autonomous drive of a vehicle according to an embodiment, where a sneezing episode has been detected;

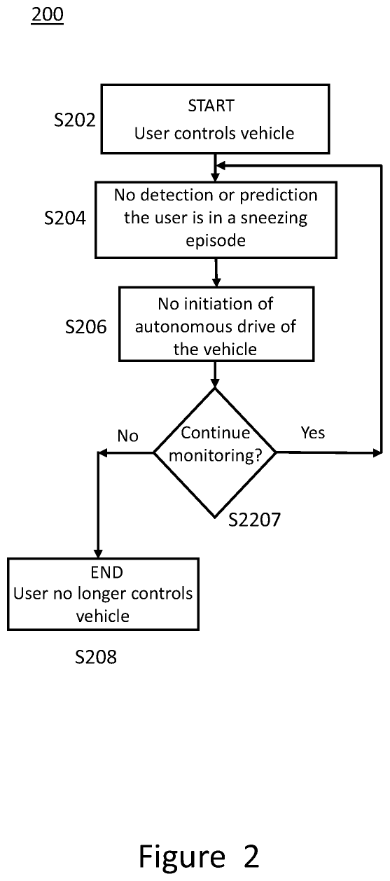

FIG. 2 illustratively shows a simplified flow diagram of a method for not initiating autonomous drive of a vehicle when the vehicle is under the control of a user, where no sneezing episode has been detected;

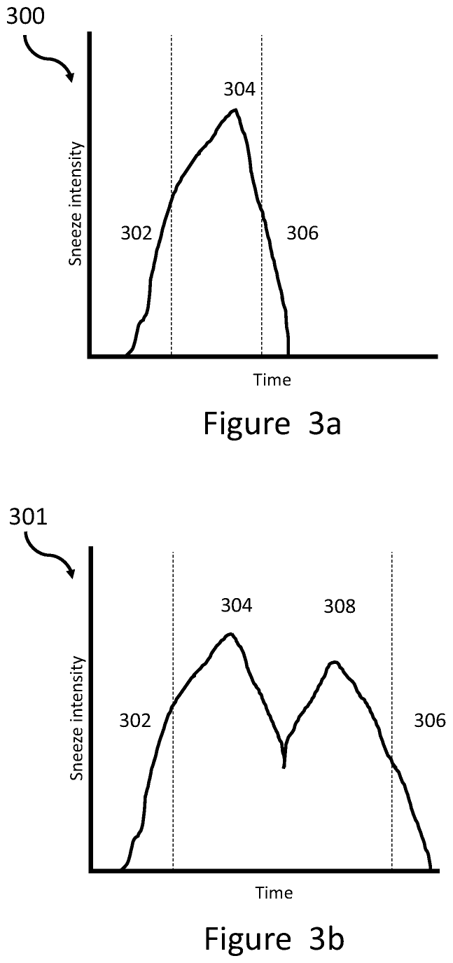

FIG. 3a illustratively shows an example sneezing episode graphically;

FIG. 3b illustratively shows another example sneezing episode graphically;

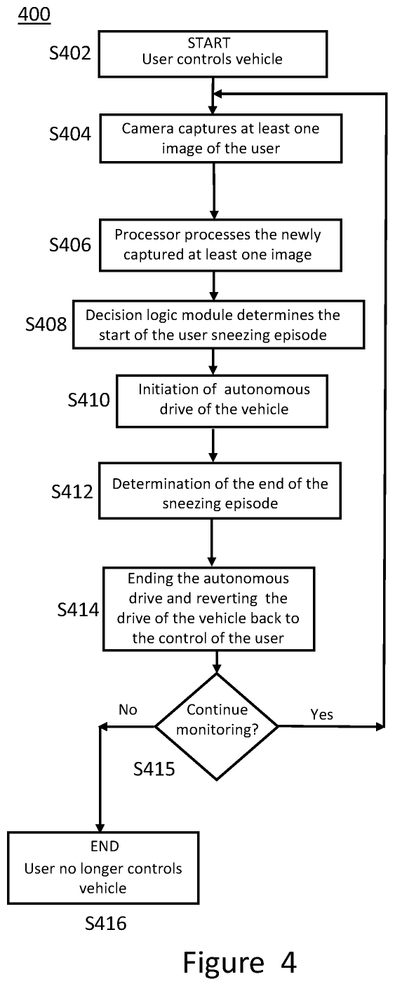

FIG. 4 illustratively shows another simplified flow diagram of a method for initiating autonomous drive of a vehicle according to an embodiment;

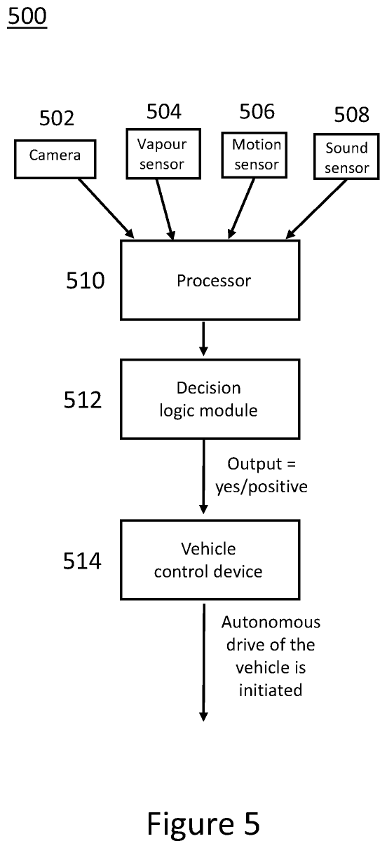

FIG. 5 illustrative shows a simplified communication diagram for the method of the invention;

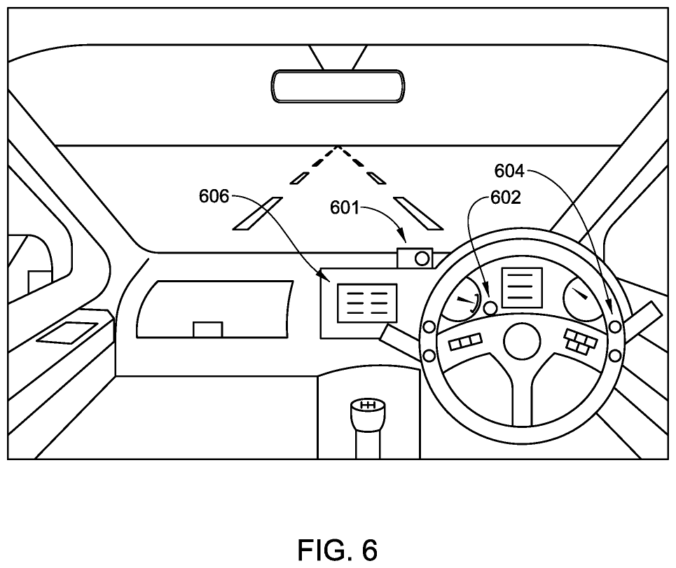

FIG. 6 illustrative shows the location of sensors in a car, which is an example of an embodiment in a vehicle;

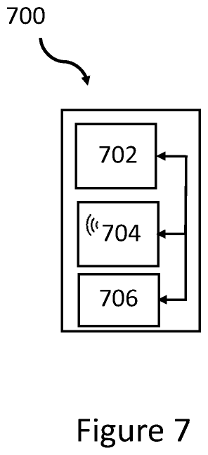

FIG. 7 illustratively shows a simplified system capable of initiating autonomous drive of a vehicle according to an embodiment;

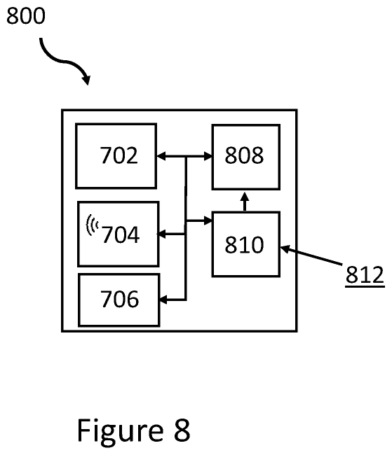

FIG. 8 illustratively shows a second simplified system capable of initiating autonomous drive of a vehicle according to an embodiment; and

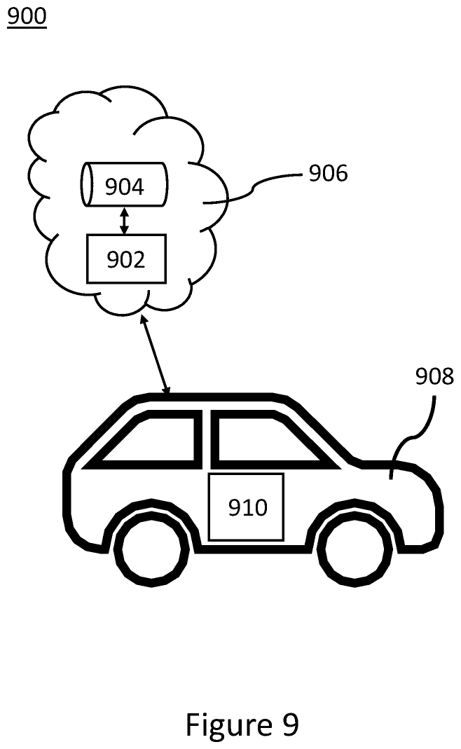

FIG. 9 illustratively shows a third simplified system (900) capable of initiating autonomous drive of a vehicle according to an embodiment.

The present techniques provide methods, systems, computer programs and vehicles for initiating autonomous drive of a vehicle and will be described more fully hereinafter with reference to the accompanying drawings. Like numbers refer to like elements throughout.

According to the present techniques, autonomous drive of a vehicle under control of a user is initiated on detection or prediction that the user of the vehicle is in a sneezing episode. The detection or prediction may be when there is detection or prediction that the user of the vehicle is in a sneezing episode.

According to a first technique, there is provided a computer implemented method of initiating autonomous drive of a vehicle when the drive of the vehicle is under the control of a user, the method comprising: detecting or predicting the start of a user sneezing episode, and initiating autonomous drive of the vehicle during the user sneezing episode. In some embodiments, after the initiating the autonomous drive of the vehicle, the method includes determining the end of the user sneezing episode, ending the autonomous drive of the vehicle and reverting the drive of the vehicle back to the control of the user.

FIG. 1 illustratively shows a simplified flow diagram of a method for initiating autonomous drive of a vehicle when the vehicle is under the control of a user, according to an embodiment (100).

At S102 the method starts. This may be for example when the user begins to operate or use the vehicle, or when the smart vehicle capabilities of the vehicle are turned on, or initiated, i.e. when the vehicle is turned on or they are turned on by the user. Here the user beings to control the vehicle. This may be for example when the user begins to drive the vehicle.

At S104, there is detection or prediction that the user is in a sneezing episode or is entering a sneezing episode; i.e. the start of a user sneezing episode. Detecting or predicting the user of the vehicle is in a sneezing episode can comprise the use of at least one sensor in the vehicle.

At S106 because there has been detection or prediction that the user is in a sneezing episode, there is an initiation of the autonomous drive of the vehicle.

At S108 the method includes determining the end of the sneezing episode.

At S110 because the end of the sneezing episode has been determined, there is the end of the autonomous drive and the reverting of the drive of the vehicle back to the control of the user.

In between S110 and S112 in FIG. 1, there is a decision element S111. The system makes a decision as to whether it should “continue monitoring” (a question). If the decision is yes, the system can be seen to loop back to the start. This “yes” may be because on reverting of the drive of the vehicle back to the control of the user the method reverts back to the user being in control and the detecting and/or predicting of the user being in a sneezing episode step of the method begins again. If the decision is “no”, then the method ends (s112). This “no” may be for example when the user of the vehicle turns the vehicle off, or when the user of the vehicle manually turns on the autonomous vehicle control, so that they are no longer in control of the vehicle and the vehicle no longer needs to monitor the user for sneezing episodes. The user may be able to choose to turn the sneezing monitoring method off, whilst still driving and being in control of the vehicle, perhaps due to a preference for not having it on. Thus, at S112 the method ends.

FIG. 2 illustratively shows a simplified flow diagram of the method where no autonomous drive of a vehicle is initiated because there is no detection of the user of the vehicle sneezing (200).

At S202 the method starts. This may be for example when the user begins to operate or use the vehicle, or when the smart vehicle capabilities of the vehicle are turned on, or initiated, i.e. when the vehicle is turned on or they are turned on by the user. Here the user beings to control the vehicle. This may be for example when the user begins to drive the vehicle.

At S204, there is no detection or prediction that the user is in a sneezing episode or is entering a sneezing episode. Thus, at S206, in contrast to S106 in FIG. 1, there is no initiation of the autonomous drive of the vehicle. This may be where there is a process undertaken which can detect or predict the start of a user sneezing episode, which here determines that the user is not currently entering or in a sneezing process, thus the decision is taken to not initiate autonomous control of the vehicle. This is a negative answer to the question of if the user is starting or in a sneezing episode.

In between S206 and S208 in FIG. 2, there is a decision element S207. The system makes a decision as to whether it should “continue monitoring” (a question). If the decision is yes, the system can be seen to loop back to the start. This “yes” may be because on reverting of the drive of the vehicle back to the control of the user the method reverts back to the user being in control and the detecting and/or predicting of the user being in a sneezing episode step of the method begins again. If the decision is “no”, then the method ends (S208). This “no” may be for example when the user of the vehicle turns the vehicle off, or when the user of the vehicle manually turns on the autonomous vehicle control, so that they are no longer in control of the vehicle and the vehicle no longer needs to monitor the user for sneezing episodes. The user may be able to choose to turn the sneezing monitoring method off, whilst still driving and being in control of the vehicle, perhaps due to a preference for not having it on. Thus, at S208 the method ends.

The term “vehicle” as used herein, in accordance with particular embodiments of the invention, preferably refers to any drivable vehicle. This refers to any vehicle operated by a user with motorized function. This can include a car, a van, a truck, a lorry, a tanker, a freighter, a bus, a caravan, a motorbike, an airplane, a personal aerial vehicle (aka manned drones), a motorhome, a tractor or other piece of motorised agriculture machinery, a tanker, a train, an airplane, a boat, a ship, a submarine, a tank, a crane, a driveable digger or other piece of motorised machinery. More specifically the vehicle can be a motor vehicle, more specifically the vehicle can be a vehicle suitable for driving on roads, more specifically the vehicle is a car, a van, a bus or a truck, a personal aerial vehicle and even more specifically the vehicle is a car. The vehicles described herein are autonomous vehicles.

The term “user” as used herein, in accordance with particular embodiments of the invention, refers to a person using or controlling a vehicle. Users may also be referred to as drivers, controllers or operators of the vehicle. The vehicle may be operated or controlled by a user, and possibly one or more other users at the same time. There can be co-users of vehicles, with varying levels of control of the vehicle. The vehicle may then also carry other people in addition to the actual users or drivers of the vehicle, these may be referred to as “passengers”.

“Control of a vehicle”, as used herein, in accordance with particular embodiments of the invention, refers to when a vehicle is being controlled by a user, for example when it is being driven by a user. User control of a vehicle may be through different control systems, for example manual controls such as a steering wheel and manual gears, or through computer control systems which utilise computers to control a vehicle. User control may be semi or partially automated, to varying degrees of autonomy.

The term “autonomous vehicle”, as used herein, in accordance with particular embodiments of the invention, refers to a vehicle which is capable of some level of automated or autonomous drive function. Autonomous vehicles may also be known as driverless vehicles, self-driving vehicles, robotic vehicles, automated vehicles, semi-autonomous or semi-automated vehicles.

“Autonomous drive” or “automated drive” as used herein, in accordance with particular embodiments of the invention, can be used interchangeably, and can be defined as the combination of different components and functions of a vehicle, such as the perception, decision making, and operation of the vehicle, wherein these functions are automated, or performed by electronics and/or machinery instead of a user or human driver.

Autonomous drive function of the vehicle may be initiated and controlled by a vehicle control device or circuit or unit (used interchangeably throughout the specification). A vehicle control circuit or device may be a computer on board the vehicle, or an embedded device which communicates with a remote computer from the vehicle, e.g. a cloud-based controller. In embodiments, the vehicle control device or circuit is connected to the drive transmission management system that controls the vehicle, so that the system may autonomously drive the vehicle according to predetermined control levels (e.g. when the user of the vehicle has switched it on, or in the embodiments disclosed herein in the event of a sneezing episode). The automated control of the vehicle functions can include control of one or more of the vehicles functions, such as:
switching the ignition, or the start control that controls the start of the vehicle, on/off;
turning the steering wheel, or the steering or steering device that controls the steer of the vehicle (e.g. a rudder for a boat) thus changing the steer, course or direction of the vehicle;
increasing/decreasing the throttle or acceleration, or the throttle control that controls the speed of the vehicle, thus changing the speed of the vehicle;
applying/releasing the brakes;
switching on/off direction indicators;
controlling lights on the vehicle (E.g. by turning on/off the headlamps, parking brakes, fog lights etc.);
activating warning signals (e.g. sounding a horn; hazard lights);
locking/unlocking the doors;
activating the windscreen wipers;
parking sensors or controls; and
changing the gear of the vehicle.

Autonomous vehicles can combine a variety of techniques to monitor their surroundings, including GPS, radar, laser light, odometry and computer vision. Advanced control devices and systems can then interpret sensory information to identify appropriate navigation paths, as well as obstacles and relevant signage.

The advantages of autonomous vehicles are many. For example, they will result in increased user safety, as autonomous drive functions can take over from the users of vehicles when safety of the user, users or passengers may be at risk, for example when the driver is undergoing a user sneezing episode. Furthermore, it is envisioned autonomous vehicles on roads will result in a significant reduction in traffic collisions and resulting injuries, losses of life, economic costs, insurance costs and time lost due to accidents. A similar increased safety is expected for the surroundings of vehicles, such as other vehicles on the roads or pedestrians on the pavements. Manufacturers also envision that generally autonomous vehicles will, for example, lead to increased traffic flow, provide increased mobility for children, the elderly disabled and poor, reduce stress of driving, reduce tiredness of users, lower fuel consumption, improve parking of road vehicles, reduce crime and improve sharing economy opportunities.

Autonomous vehicles are typically changeable or switchable between an autonomous driving mode and a user-controlled mode. It is envisioned that autonomous vehicles will have multiple different autonomous driving modes, perhaps all within a single vehicle, each set at a different level of control. These different levels may require different levels of user input and will depend on the situation they are being employed for. How these are categorised depends on the vehicles and the manufacturer. In the United States, the National Highway Traffic Safety Administration (NHTSA) has developed a notation system for a number of different levels vehicle automation, covering a range of vehicle automation, ranging from level 0 (no control systems automated) to level 4 (fully automated). In more detail:

Level 0—No-Automation—the user is in complete and sole control of the primary vehicle controls (e.g. brake, steering, throttle, and motive power) at all times, and is solely responsible for monitoring the drive and is ready for safe operation of all vehicle controls. At level 0 vehicles can still have some level of user convenience functions (e.g. vehicle collision warnings), but these do not control any primary vehicle controls.

Level 1—Function-specific Automation—one or more specific functions are automated but operate independently from each other if more than 1 is automated. The user still has overall control and is responsible for safe operation but can chose to relinquish authority of one or more specific functions, e.g. assisting the user in braking or speed controls, but not both at once. None of the functions work in unison.

Level 2—Combined Function Automation—at least two primary control functions can be automated and are designed to work in unison to relieve the user of control. For example, in a car or a truck this can be adaptive cruise control in combination with lane centering. The user is still responsible for monitoring the roadway and safe operation and is expected to be available for control at all times on short notice, and to still be monitoring the road for safety purposes.

Level 3—Limited Self-Driving Automation—at this level the user can relinquish full control of all safety-critical functions in certain conditions, wherein it would be safe to do so. The user should still be available for control, however is not likely to need to constantly control the vehicle for safety purposes.

Level 4—Full Self-Driving Automation—where the vehicle can perform all safety-critical driving functions and monitor roadway conditions for an entire trip. At full autonomous control it is envisioned that the user of the vehicle will be able to do other functions whilst the drive of the vehicle is out of their control.

These exemplary levels are just an example of one system of different possible levels of autonomous control of a vehicle. As systems develop, different definitions and classification system are envisioned, within the same principles of different levels of control being possible.

Different autonomous drive systems may be referred to as partially autonomous, half autonomous, semi-autonomous etc., depending on the different possible levels of automation of the drive function. A single system may switch between different levels of autonomous driving, depending on the level desired or selected by the user or the reason for the autonomous drive being initiated (e.g. when the user of the vehicle has switched it on, or in the case disclosed herein in the event of a sneezing episode).

In embodiments herein, the autonomous drive will allow the user of the vehicle to be in a user sneezing episode without compromising safety, as autonomous drive will take control of the vehicle for at least the duration of the sneezing episode. This level of autonomous drive could be at any one of a number of different levels; different degrees of autonomous drive can be envisioned depending on the level of technology in the car, the user's preferences and the level of drive needed (which may depend on for example the length of the sneezing episode). A user may be able to choose the level of autonomous control that takes over when the user has been detected as in a sneezing episode.

“User sneezing episode” or “sneezing episode” or “sneezing period” (all used interchangeably throughout) as used herein, in accordance with particular embodiments of the invention, is the period leading up to, during and after a sneeze or multiple sneezes, inclusively. A user sneezing episode can be further defined as a period in which somebody (here the user of a vehicle) is preparing to sneeze, sneezing and/or recovering from a sneeze. A user sneezing episode is not just the act of sneezing itself, but includes both the build up to and aftermath of a sneeze, or multiple sneezes. When driving, it is not just the actual act of sneezing which can lead to the user of the vehicle being incapacitated or debilitated, with a compromise in safety, but also the build up to and aftermath of a sneeze. Prior to sneezing, for example a user may shut their eyes, lose control of their limbs and tilt their head backwards or forwards before the sneeze even occurs. Similarly, after a sneeze, a user may feel incapacitated, for example keeping their eyes shut. Also, the result of a sneeze e.g. wiping of any mucus blown out of the nose or the mouth, looking for tissues, wiping of hands which are wet or covered in mucus, can cause a user to be distracted, resulting in a compromise in safety. All of these acts can distract a user from the road and comprise safety. Different people have sneezing episodes and react to sneezes in a large variety of different ways, some people taking longer to sneeze or recover from a sneeze than others.

Sneezing is a normal bodily function which results in the expiration of air from the lungs, through the mouth and/or nose. Sneezing can be characterised as one or more one of: involuntary, sudden, violent, spasmodic and audible. Sneezing is often caused by irritation of the nostrils, e.g. possibly due to dust or airborne particles entering the nostrils, or due to a strong smell irritating the nasal passages of a user. Sneezing episodes can be induced when the nostrils are irritated to airborne particulates, or strong smells such as perfumes or deodorants.

Furthermore, a “sneezing episode” can refer to multiple sneezes occurring one after another. Thus, “sneezing episode” is possibly referring to multiple sneezes, along with the build-up and aftermath. Sneezes do not often happen in isolation, particularly when something has stimulated a user to sneeze, such as dust particulates; it is common for people to sneeze multiple times in a row.

Furthermore, a “sneezing episode” can refer to the feeling after or before a sneeze, where a user feels like they are going to sneeze, but does not actually sneeze. This feel can be similarly incapacitating to user of a vehicle, causing a loss of control. An actual sneeze need not occur for a “sneezing episode” to take place, but a “sneezing episode” is defined as a sneezing episode if one or more of the characteristics of a sneezing episode occur. The same resulting loss of control or compromise of safety can result when a user believes they are going to sneeze, or can feel a sneeze coming, i.e. entering a sneezing episode, but without an actual sneeze occurring.

FIG. 3a illustratively shows a graph 300 depicting a user sneezing episode, where the sneezing episode consists of a single sneeze. Time is represented on the x axis, representing the passing of time during the user sneezing episode. Sneeze intensity is represented on the y axis, representing how strong the feeling of sneezing is to the person undergoing the sneeze, i.e. the maximum point represents a sneeze. Reference sign 302 notes the section of the graph showing the build-up to the sneeze, before the sneeze. Reference sign 304 notes the section of the graph which is an actual sneeze, characterised with the highest intensity of sneeze. Reference sign 306 notes the section of the graph depicting the aftermath of the sneeze, before the intensity of the sneeze returns to 0, i.e. the user is no longer in a sneezing episode. The sneezing episode comprises a build-up of sneeze intensity, a peak, and a drop off of intensity of sneezing feeling or level.

FIG. 3b illustratively shows a graph 301 depicting a user sneezing episode, where the sneezing episode consists of two sneezes. As with FIG. 3a, the passing of time is represented along the x axis. Here, a user is experiencing multiple sneezes, resulting in multiple increases and decreases in sneezing intensity, before the drop off in sneezing intensity. Reference signs 304 and 308 show two repeated sneeze peaks, of varying intensity, with 302 and 306 the before and aftermath of the sneezing episode, as with FIG. 3a.

These simple graphical representations are to illustrate that a single sneezing episode can vary from episode to episode. This outlines that a sneezing episode is not just an actual sneeze, but encompasses the build-up and aftermath of a sneeze. It also applies to multiple sneezes occurring in succession.

A sneeze can leave a user of a vehicle incapacitated or debilitated. A sneezing episode can be characterised by facial gestures associated with being in a sneezing episode (eyes partially shutting, eyes shutting, nostril size increasing, mouth opening and eyebrows raising), the user covering their mouth, heavy breathing, a sharp intake of breath, eyes becoming smaller, head tilting backwards, head tilting forwards or repeated sniffing, for example. This can result in a loss of eye sight (due to eyes shutting), loss of arm control (possibly resulting in letting go of the car steering wheel), loss of leg control (possibly resulting in an unwanted change in the use of pedals in e.g. a car) jerking movements (possibly resulting in moving of a steering wheel in unwanted direction) and/or taking eyes off the road (due to head movements and eye shutting).

The detecting or predicting the user of the vehicle is in a user sneezing episode can comprise using a sensor. In some embodiments the sensor is a camera, which captures at least one image of the user. In some embodiments the method includes capturing at least one image of the user, processing the newly captured at least one image, and determining if the user of the vehicle is in a sneezing episode. In some embodiments the processing of the newly captured at least one image can be carried out by a processor. In some embodiments the determining if the user of the vehicle is in a sneezing episode can be carried out by a decision logic module. In some embodiments, the camera will capture a new image, extract the features related to the sneezing action and compare with the previously stored sneezing features (possibly involving a processor or other parts of a system to do do).

“Sensor” as used herein, in accordance with particular embodiments of the invention, is a device which is configured to sense, detect or measure something about the user of the vehicle. This may be a physical change or property or response of the user. The sensor may then record the finding and then report on or response to this finding. Sensor can also mean or be used interchangeably with “detector” or “measurement device” or “sensor device”. A sensor may be part of a configuration of multiple sensors, which monitor environmental conditions or changes. The multiple sensors could be multiple different sensors of the same type, or multiple different types of sensors (or a combination of both). For example, sensors may be configured to monitor changes in the user of a vehicle, such as a camera configured to monitor movements of the user of a vehicle.

In some embodiments, a camera is configured to sense a change in at least one physical movement of the user. This may then trigger the camera to capture at least one image of the user. The change in the movement of the user of the vehicle may be a physical movement which is associated with sneezing. On detection of a physical movement which is associated with sneezing, a camera may then send the newly captured at least one image to the processor. A processor can then process the newly captured at least one image. The data resulting from the processing of the newly captured at least one image can then be sent to a decision logic module. A decision logic module can then undertake a decision making process, to determine if the user of the vehicle is in a sneezing episode. If the decision logic module determines that the user of the vehicle is in a sneezing episode, then an indication will be made to: the vehicle, the vehicle control module and/or the user of the vehicle, which will indicate that the user of the vehicle is currently in a sneezing episode. This can then trigger the initiation of the autonomous drive of the vehicle by a vehicle control device or circuit.

FIG. 4 illustratively shows a simplified flow diagram of another method for initiating autonomous drive of a vehicle when the vehicle is under the control of a user according to an embodiment (400). This method is an elaboration of the method illustrated in FIG. 1.

At S402 the method starts. This may be for example when the user begins to operate or use the vehicle, or when the smart vehicle capabilities of the vehicle are turned on, or initiated, i.e. when the vehicle is turned on or they are turned on by the user. Here the user beings to control the vehicle. This may be for example when the user begins to drive the vehicle.

In this embodiment, the detecting or predicting the user of the vehicle is in a sneezing episode comprises the use of at least one sensor, wherein the sensor is a camera. At S404 the camera captures at least one image of the user.

At S406 a processor processes the newly captured at least one image and at step S408 a decision logic module determines if the user of the vehicle is in a sneezing episode or the start of the user sneezing episode.

At S410 because in this illustrative figure there has been a positive detection or prediction that the user is in a sneezing episode, there is initiation of the autonomous drive of the vehicle.

At S412 is the determination of the end of the sneezing episode.

At S414 because the end of the user sneezing episode has been determined, there is the end of autonomous drive and the reverting of the drive of the vehicle back to the control of the user.

In between S414 and S416 in FIG. 4, there is a decision element S415, the same as can be seen in FIG. 2 and FIG. 4. The system makes a decision as to whether it should “continue monitoring” (a question). If the decision is yes, the system can be seen to loop back to the start. If the decision is “no”, then the method ends (s416). Thus, at S416 the method ends.

“Camera”, as used herein, in accordance with particular embodiments of the invention, is a camera capable of capturing at least one image of the user of the vehicle. The camera may be a digital camera, a micro video camera, a high-speed camera, dashcam, a cabin view cam, a taxicam, an onboard camera, a stereo camera. The camera may be capable of taking three dimensional images or videos of the user of the vehicle. The camera may be a still camera, capable of transferring images using electronics to store digital images in a computer memory. The camera may be a vehicle mounted camera and may be positioned so that the user cannot see the camera, i.e. the camera may be hidden. The camera may be, for example, located in the dashboard of the vehicle. The camera may have multiple other purposes and sensor and the sensing of a change in at least one physical movement of a user may be just one function of the vehicle mounted camera, e.g. it may be part of a biometric device or system. As used herein, “camera” may refer to multiple cameras (i.e. 2, 3 or 4 separate cameras) or a camera arrangement or configuration consisting of more than 1 camera. Multiple camera may be able to capture 3D images of a user, or enable image capture from multiple different angles. Images taken by multiple camera could be stored and processed to become 3D images. 3D image capture or image capture from multiple different angles by multiple camera may improve the determination of the user being in or not in a sneezing episode. The method may involve the capture of a new image, extraction of the features related to the sneezing action and comparison with the previously stored sneezing features or images.

The camera can capture at least one image of the user. The camera may be able to capture the at least one image of the user when there is a change in movement of the user. The change in the movement of the user of the vehicle may be at least one physical movement which is associated with a sneezing episode. The camera may be configured to be able to detect the change in movement of the user associated with sneezing, and begin to capture the at least one image of the user. The at least one image may then be used in some form of image recognition, through an image recognition algorithm or in image recognition software.

In some embodiments, the at least one image captured by the camera may be a single image, a video, video footage, burst images, or series of images and/or videos captured over a period of time. There may be a predetermined image capture period which begins once the camera senses the user of the vehicle is entering a sneezing episode or is undertaking at least one physical movement which is associated with a sneezing episode. The camera may capture a pre-determined number of images, which is a sufficient number of images to be able to determine if the user is in a sneezing episode. This sufficient number of images may be 2 images, 3 images, 4 images, 5 images, 10 images, up to 10 images, or up to 20 images. This will depend on the image recognition algorithm/software etc. used.

After capturing the initial first at least one image of the user of the vehicle, the camera may then stop the capture of the at least one image of the user. The stop of the image capture may be because there is a set predetermined time period to capture the at least one image, initiated once the movement is detected and stopped after a predetermined time. The stop may be because after the processing of the image by the processor, a decision logic module has indicated that the user either is or isn't in a sneezing episode, and thus indicates to the camera that the image capture can end. Thus, the stop could be due to the user not being in a sneezing episode, or the user being in a sneezing episode. The stop could be because a set number of images has been taken. This set number of images could be 2 images, 3 images, 4 images, 5 images, 10 images, up to 10 images, or up to 20 images. The image capture may be over a set time period. The set time period may be under 1 second, 1 second, 1.5 seconds, 2 seconds, 2.5 seconds, 3 seconds, 3.5 seconds, 4 seconds, 4.5 seconds, 5 seconds, 6 seconds, 7 seconds, 8 seconds, 9 seconds, 10 seconds or a suitable time period to capture a sufficient number of images of the user for the determination of if the user is in a sneezing episode. This will depend on the image recognition algorithm/software etc. used.

In some embodiments the camera continually takes images or video footage of the user of the vehicle, always capturing images or always taking video footage of the user of the vehicle. In some embodiments, there is a continual loop of image (or video) capture, image (or video) processing and resulting decisions being made, to determine if the user is entering a sneezing period. This can be initiated on start-up of the vehicle, and can be without a sensor necessarily detecting something to indicate that the user of the vehicle is entering a sneezing episode. This continual monitoring may be a function which the user of the vehicle can switch on, for example if they believe there is an increased chance of them entering a sneezing episode in that use session (e.g. due to a medical condition such as a cold an allergy).

In some embodiments, the method includes sensing a change in at least one physical movement of the user, wherein the at least one physical movement of the user is one associated with sneezing. In some embodiments, the vehicle mounted camera is able to detect or sense the change in the physical movement of the user, wherein the physical movement of the user is one associated with sneezing. In some embodiments, the at least one physical movement of the user associated with sneezing is selected from the group consisting of: facial gestures associated with being in a sneezing episode, the user covering their mouth, heavy breathing, a sharp intake of breath, eyes becoming smaller, head tilting backwards, head tilting forwards and repeated sniffing. In some further embodiments, the facial gestures associated with being in a sneezing episode are selected from the group consisting of: eyes partially shutting, eyes shutting, nostril size increasing, mouth opening and eyebrows raising.

In some embodiments, the method includes comparing the newly captured at least one image of the user to at least one historical image of the user stored in a memory. The method may involve the extraction of features related to the sneezing action, i.e. specific parts of the image/user's face may be focused upon. This may be that a processor compares the newly captured at least one image of the user to at least one historical image of the user stored in a memory and then a decision logic module takes this comparison into account when determining if the user of the vehicle is in a sneezing episode. In some embodiments the method includes comparing the newly captured at least one image of the user to multiple historical images of the user from multiple historic time points stored in a memory. This may be where a processor compares the newly captured at least one image of the user to multiple historical images of the user from multiple historic time points stored in a memory. In some embodiments the at least one or multiple historical image(s) of the user stored in a memory is an image or are images taken on the same day, in the same use session of the vehicle, or within the last one minute, a 1 minute period, a 5 minute period, a 10 minute period, a 20 minute period, a 30 minute period, a 40 minute period, a 50 minute period, a one hour period, a 2 hour period, a 3 hour period, a 4 hour period or a suitable time period whereby if the user has sneezed in that time period there is an increased likelihood that the user will enter a sneezing episode again. Reasons for the user being more likely to enter a sneezing period are discussed later on.

In some further embodiments, the method includes comparing the newly captured at least one image of the user to multiple images stored in a memory, wherein the multiple images stored in a memory are images for generating a positive or negative match of the user being in a sneezing episode or the user not being in a sneezing episode, when compared with the newly captured at least one image of the user. This may be that a processor carries out the comparing.

In some embodiments, sneeze detection/prediction can be made in a user-neutral manner. Instead of storing historical images of a user in memory, the essential features of the sneeze action are extracted in a user-neutral manner and stored in memory. The new images of the current user are taken, and the essential features of the sneeze action are extracted and compared to the previously stored features to detect/predict a sneeze action.

“Memory”, “computer memory”, “memory circuit” or “memory module”, as used herein interchangeably, in accordance with particular embodiments of the invention, may be a database of stored image data. Memory capable of image storage are memory elements standard in the art. “Image” as used herein, in accordance with particular embodiments of the invention, refers to an image in in a processable file formats (e.g. JPEG/JPG, GIF, TIFF, BMP, PNG, PPM/PGM/PBM/PNM, or other such suitable image formats). These can be known as raster or bitmap images, representing the image pixels. Alternatively, images may be stored as vector image formats, which contain a geometric description of the image. Images can be defined in terms of 2D points connected by lines and curves to form polygons and other shapes This can be rendered for processing. There are suitable 2D or 3D vector image formats. Images may be compressed for ease of transfer or storage. Images taken by multiple camera could be stored and processed as 3D images.

The processing may be carried out by a processor. “Processor”, as used herein, in accordance with particular embodiments of the invention, is a processor capable of processing the at least one image of the user, or data from the at least one image of the user, captured by the camera. The method comprises the use of a data processing device having the capabilities and functionality of the methods of the outlined techniques, which may comprise, for example a computer, an onboard computer, a mobile phone, a tablet or a laptop although this list is exemplary only. The processor may comprise the necessary processing power and applications/programs/policies to process the image data thereon. The processor may be located with the camera, or may be located elsewhere in the vehicle, e.g. as part of the autonomous drive control device(s), system(s) or computer. The camera may have limited processing and storage capabilities, and in embodiments the camera may be paired with a device and transmits the image or image data to the device, e.g. a processing device. The processing may then take place in the device.

Image processing technologies are standard in the art and can be employed to extract or analyse images or data from images. Images or data from images can be compared to other images or data from other images, such as historical images of the same users or images designed to generate a positive or negative match of the user being in a sneezing episode. These other images may be template images or template image data. The images or data extracted from the image(s) of the user of the vehicle may be compared with the data or template data in a database. Processors according to embodiments herein are image processing processors capable of using image processing apparatus or processing performing units for performing predetermined processing of received image data. They may be also connected to an output device, to output information. Thus, the processor is then capable of outputting the information to the decision logic module.

In some embodiments, processing occurs in a computer on-board the vehicle. The camera may transmit the data to a processor on-board the vehicle. In other embodiments, processing occurs on a computer located remote from the vehicle. The camera may transmit the data to a processor remote from the vehicle.

The camera may transmit the image or image data to either or both of a processor on board the vehicle (e.g. a computer) or a processor located remote from the vehicle (e.g. a cloud-based computer system) for the processing. The processing could partially be carried out by both a processor on board the vehicle, or a remote processor.

The determining step of the method may be carried out by a decision logic module. A decision logic module can utilise the data resulting from such image processing (e.g. the comparison of historical images or memory stored images or templates in a database to the newly taken images) into account when determining if the user of the vehicle is in a sneezing episode.

“Decision logical module”, as used herein, in accordance with particular embodiments of the invention, is a module or part of a computer system which comprises components which make it capable of receiving data from a processor, to make decisions. The decisions herein relate to whether the user of a vehicle is in a user sneezing episode or not. This decision making process and determination may be also take into account additional factors to predict if the user is in a sneezing episode or not in a sneezing episode. The decision logic module is merely a term meant to encompass a possible series of modules or (computer) elements capable of carrying out the outlined function. Such logic elements may comprise components such as logic gates in, for example a programmable logic array or application-specific integrated circuit or a programmable/dedicated processor (e.g. CPU, GPU, DSP). Such a logic arrangement may further be embodied in enabling elements for temporarily or permanently establishing logic structures in such an array or circuit using, for example, a virtual hardware descriptor language, which may be stored and transmitted using fixed or transmittable carrier media. A decision logic module may generate a “positive” or “negative” answer to a question, e.g. “is the user of the vehicle in a sneezing episode?”, where a positive answer is yes, “yes, the user is in a sneezing episode”, and a negative answer being no, “no, the user is not in a sneezing episode”.

The decision logic module will be capable of making a decision, based on the data received from the processor, as to whether the user of the vehicle is in a sneezing episode. The decision logic module is where the determination step takes place. The decision making process may also take into account multiple different factors. This decision is what determines if there is initiation of the autonomous drive of the vehicle by a vehicle control circuit or device. If the decision logic module determines that the user of the vehicle is not in a sneezing episode, then there is no initiation of the autonomous drive of the vehicle by a vehicle control circuit. If the decision logic module determines that the user of the vehicle is in a sneezing episode, then there is initiation of the autonomous drive of the vehicle by a vehicle control circuit. The decision of the decision logic module can be in the form of a positive or a negative decision as to whether the user of the vehicle is in a sneezing episode. Or the decision can be in the form of a percentage likelihood, or it may be both, with a decision of a positive or a negative sneeze along with a percentage (%) likelihood, accuracy or compensation along with the positive or negative decision.

The decision logic module may undertake multiple decision making processes, which may be based on multiple images or videos captured separately. These multiple decisions can be taken over a time period, e.g. a predetermined time period which begins when the first decision is made which determines that the user of the vehicle is in a sneezing episode. On undertaking multiple decisions as to whether the user of the vehicle is in a sneezing process or not, the decision logic module can combine the decisions into a single decision or calculation, based on the outcome of the multiple different decisions made, which may be in a set time period. The decision logic module may improve in accuracy the more decisions processed about a single possible sneezing episode, e.g. an overall single decision making process may improve the more individual decision making processes for a single sneezing episode undertaken. When a decision logic module includes a percentage (%) likelihood, accuracy or compensation along with the positive or negative decision then this may be taken into account when multiple decisions are combined to determine if the user in a sneezing episode.

In some embodiments, there are multiple determinations of if the user of the vehicle is in a user sneezing episode during a user sneezing episode, wherein the later determinations take into account the earlier determinations, so as to improve the accuracy of the decision making process as time progresses throughout a sneezing episode The decision logic module may be configured to be able to undertake repeat, multiple, decisions during a single user sneezing episode. These determinations are refined and/or improved as time progresses throughout a sneezing episode. This is because as time progresses through a sneezing episode, more data (e.g. images taken of a user in a sneezing episode, or moisture detected by a moisture sensor) may be processed and taken into account in the decision making process by the decision logic. This may be based on new data received regarding the sneezing process as time progresses throughout the sneezing process. For example, the decision logic may be using machine learning techniques (e.g. supervised, unsupervised and reinforced learning) to learn from the data in order to make the decisions. In time, the decision logic can update the learning parameters of the machine learning models derived from the new data to improve the prediction accuracy of sneeze detection. This may involve the use of multiple decisions with a % likelihood, accuracy or compensation being factored into the multiple decisions progressively, so each time a decision is made.

As a sneezing episode progresses the decision logic module may be required to make multiple decisions regarding a single sneezing process. There may be multiple inputs from the processor(s) and/or sensor(s) throughout a single sneezing episode, which then in turn contribute to multiple decision logic module decisions. It may be that the decision logic module initially decides upon a negative outcome, that a user is not in a sneezing episode, from the first batch of data it receives, however it may be that upon receiving the second batch of data, which will be from later time point in the sneezing process, the decision logic module may then actually determine a positive decision, that the user is in fact in a sneezing episode. This may possibly also take into account the decision and/or a percentage (%) likelihood, accuracy or compensation along with decision. The decision logic module may undertake repeat, multiple, decisions which take into account the previous decisions, so as to refine the decision making process as time progresses throughout a sneezing episode, based on new data received regarding the sneezing process.

In some embodiments, the determining occurs in a computer on-board the vehicle. In some embodiments, the determining occurs in a computer located remote from the vehicle. The processor or processor computer may transmit the processed data (e.g. the image data) to a decision logic module on board the vehicle (e.g. a computer) or a decision logic module located remote from the vehicle (e.g. to a cloud-based computer system) for the determining. In some embodiments, the decision logic module is on-board the vehicle. In some embodiments, the decision logic module is located remote from the vehicle.

Both the processor and the decision logic module may be on-board the vehicle and able to communicate with each other as they are physically connected. The processor may transmit processed data to the decision logic module on-board the vehicle. In other embodiments, the decision logic module may be located remote from the vehicle. Here, the processor may be on-board the vehicle, or the processor may also be remote from the vehicle. The on-board processor may transmit the data to a remote decision logic module. The processor and decision logic module may be one and the same, the same processor or computer module. The processor and decision logic module may be part of the same computer system, which may be a computer on-board the vehicle or it may be remote from the vehicle.

When the processor and/or the decision logic module are remote, they may be part of a cloud-based storage, processing and/or decision logic network. There may be a service and/or database located on the cloud which the on-board camera, processors and/or decision logic module may be able to use. On-board processing or decision logic module decisions may be made partially on board and partially remote, for example partially in the cloud and partially on-board. The processing and/or determination could be carried out by an on-board processor and then the data still also sent to a remote processor/computer. This may carry out back up processing or determination, or to confirm the processing or decisions made on board the vehicle, either immediately or at a later date.

The data from this may be stored either on-board or remotely. This data may later form part of a user profile, template or part of a personalised data set for specific users, or as part of specific user profiles. The data may be taken into account in future determinations of a user being in a sneezing episode or not. This may result in improvements to future decision making.

When the method is carried out, the determining may take into account a number of different factors. These factors may result in an increased or decreased likelihood of determining if a user is in a user sneezing episode. A decision logic module may make a determination or a calculation as to whether the user is in a sneezing episode including such factors.

In some embodiments, the determining takes into account additional factors selected from the group consisting of: one or more medical conditions likely to cause an increase in the number sneezing episodes experienced by the user, the weather, outside pollen count, a sudden increase in sunlight intensity, the time of the year, particulate count in the air, and the number of sneezing episodes the user of the vehicle has had when previously using the vehicle on the same day. In some embodiments, the one or more medical conditions likely to cause increased sneezing episodes is selected from the group consisting of: an allergy, rhinitis, allergic rhinitis, hayfever, a cold, influenza, a viral respiratory infection, neurological condition, nasal polyps, a medical condition for which the user is taking medication, wherein the medication can cause an increase in sneezing episodes. The decision logic module can take into account such additional factors when determining if the user of the vehicle is in a sneezing episode.

Allergens can cause a sneezing episode; allergic reactions to allergens in the air can cause sneezing. This can be “hay fever” which is also known as an allergy to pollen, where allergies to pollen from plants e.g. trees, grass, or flowers, can cause an allergic reaction and resultant increase in sneezing episodes in a user. “Pollen count” is an index of the amount of pollen in the air, so those who suffer from allergies to pollen know how likely they are to suffer from allergies that day. Alternatively, allergies to animals or dust can cause sneezing episodes. Other airborne particles, such as perfume or deodorants may cause a form of allergic reaction and a user to have a sneezing episode.

Sneezing can be affected by external environmental factors, as well as the pollen count such as the weather. Weather can affect the level of pollen or particulates likely to induce a sneezing episode in the air, e.g. a reduced pollen count due to wind or rain likely to cause a decrease in allergic reactions and sneezing. The vehicle may be able to detect external environmental factors e.g. the weather or pollen count, or the user may input this data into the system, or the data may be accessible remotely e.g. from the cloud or an external device as part of the smart or autonomous car control system.

A sudden increase in sunlight intensity can cause a sneezing episode. Sneezing induced by light is estimated to occur in 18 to 35 percent of the population and is known as the photic sneeze reflex (PSR) or the ACHOO (Autosomal dominant compulsive helio-ophthalmic outbursts of sneezing) syndrome. A sudden increase in daylight or bright artificial light can cause a photic sneeze reflex and could be caused by for example emerging from a tunnel into daylight or by another vehicle's headlights. The vehicle may be able to detect a sudden increase in light intensity and know that there is an increased likelihood of the user entering a sneezing episode as a result of the increased light intensity. There may be light sensors as part of the vehicle.

The time of the year can also be an indicator of how likely a sneezing episode is to occur. In winter users of vehicles are more likely to be suffering from seasonal diseases, such as influenza or colds. In summer, those users who suffer from allergies such as hay fever are more likely to enter a sneezing episode, due to a likely increased pollen count in the air. These can be seasonal, or even month dependent in the case of different allergies.

Particulate count in the air can also cause a sneezing episode. A vehicle may be able to measure the particular count in the air and the decision logic module may be able to take this into account when determining if the user of the vehicle is in a sneezing episode. Particulates in the air, for example dust, pet hair, deodorants, perfumes, sand or paint may cause irritation or the nose or nasal passages and cause a sneezing episode.

In some embodiments, the determining takes into account an input from the user to indicate that for a period of time there is an increased likelihood of them entering a sneezing episode. This can be inputted by the user via a user interface, possibly into the decision logic module or into the overall system responsible for the method of the embodiments described herein. The user may indicate their increased likelihood of them entering a sneezing episode due to any one of: the user having one or more medical conditions likely to cause an increase in the number sneezing episodes, the weather, outside pollen count, the time of the year, particulate count in the air, and the number of sneezing episodes the user of the vehicle has had when previously using the vehicle on the same day. The one or more medical conditions likely to cause increased sneezing episodes may be selected from the group consisting of: an allergy, rhinitis, allergic rhinitis, hayfever, a cold, influenza, a viral respiratory infection, neurological condition, nasal polyps, a medical condition for which the user is taking medication, wherein the medication can cause an increase in sneezing episodes. The decision logic module may take these into account as part of the determining of if the user is in a user sneezing episode.

In some embodiments, the determining takes into account the number of user sneezing episodes the user has had in a given time period, wherein an increased number of user sneezing episodes results in an increased likelihood of determining the user of the vehicle is in a user sneezing episode. This can be over a specified period of time, the specified period of time may be within the last one minute, 5 minute period, 10 minute period, 20 minute period, 30 minute period, 40 minute period, 50 minute period, hour, 2 hours, 3 hours or 4 hours or suitable time period whereby if the user has sneezed in that time period there is an increased likelihood that the user will enter a sneezing episode again. The decision logic module may take this into account as part of the determining of if the user is in a user sneezing episode.

In some embodiments, the detection or prediction of the user of the vehicle being in a sneezing episode is because the user of the vehicle or a passenger in the vehicle has indicated to the vehicle that the user is in a sneezing episode. In some further embodiments, the user of the vehicle or a passenger in the vehicle has indicated to the vehicle that the user is in a sneezing episode by: giving a verbal indicator to the vehicle or using a physical input to the vehicle that the user is in a sneezing episode, and in some specific embodiments the physical input to the vehicle that the user is in a sneezing episode is the user or the passenger pressing a button or using a switch or a dial which signals to initiate the autonomous drive of the vehicle. In the event that the user knows they are sneezing, or a passenger of the vehicle notices that the user of the vehicle is in a sneezing episode, they can indicate this to the vehicle. This may be the first indicator to the vehicle that the user is entering the sneezing episode, it may happen before the detection or prediction of the vehicle itself, or it may provide a positive affirmation to the system responsible for the methods of the initiation of the autonomous drive, where the system may have already determined that the user of the vehicle has entered a sneezing episode. The decision logic module may take into account the user or the passenger of the vehicle indicating to the vehicle that the user is in a sneezing episode. The verbal indicator that the user of the vehicle is sneezing may be a pre-set verbal indicator, such as a word, which on which on detecting (e.g. with the sound sensor) the vehicle will automatically initiate the autonomous drive of the vehicle. Alternatively, the processor and decision logic module may be involved and the initiation of autonomous drive may not be automatic. The user may be able to set the keyword themselves, for example the user may be able to say or shout “sneeze” and the vehicle will detect the keyword and initiate autonomous drive. There may be language differences or user voice differences between the verbal indicators by which the vehicle is informed that the user is in a sneezing episode. Alternatively, or as well, there may be something that the user or passenger of the vehicle can use to physically indicate to the vehicle that the user of the vehicle is in a sneezing episode. This may be in the form of a button to press, a switch to press or a dial to turn.

In some embodiments the detecting or predicting the user of the vehicle is in a sneezing episode comprises the use of at least one additional sensing method for detecting or predicting the user of the vehicle is in a user sneezing episode, wherein the additional sensing method is one or more of the following: vapour or moisture sensing to detect vapour or moisture particles blown from the user, piezo, air movement, air flow or pressure sensing to detect the intensity of air blown out by the user, sound sensing detecting the user making a sound associated with being in a sneezing episode; or motion sensing to detect movement of the user. The additional sensing may be carried out by the use of at least one additional sensor. These sensors will, as described with the camera sensor above, collect data to be processed. This data can be inputted into the processor, to process and then to transmit to a decision logic module. The use of an additional sensor may provide further data to the processor and/or the decision logic module which is taken into account when determining if the user of the vehicle is in a sneezing episode. These additional sensors can be located in places where it is suitable for them to have maximum efficiency in collecting data for their purpose, e.g. a vapour sensor may be located on a dashboard or steering wheel wherein the moisture blown out from a user during a sneezing episode may land. Although the additional sensors can detect a sneeze in a user alone, a higher degree of accuracy and detection certainty in the embodiments herein is provided if the additional sensors are used in conjunction with a camera, or other such a primary sensor for capturing at least one image of the user.

The additional sensor could be a vapour or moisture sensor which can detect the resulting moisture particles blown from a user when the user sneezes. As a sneeze is the expiration of air from the lungs, through the mouth and/or nose, this is often accompanied with moisture or vapour being blown out of the lungs, and detection of this may help in determining if the user is undergoing a sneezing episode. The sensor may be able to detect a very low level of moisture, which non-the-less would be unusual to end up on the e.g. dashboard of the car for any other reason in normal use of a vehicle. The expiration of air may also be detected by a piezo, air movement, air flow or pressure sensor, which detects the intensity of air blown out by the user. The vapour or moisture sensor may be able to detect chemicals in the vapour or moisture sensed which are indicative of a sneeze, to distinguish the vapour or moisture detected from other vapour or moisture.

The additional sensor could be a sound sensor detecting the user making a sound associated with being in a sneezing episode. This sound can be captured or recorded by the sound sensor and then the processor may be able to process this sound and compare it to a sound stored as data in a memory, and wherein the decision logic module takes this comparison into account when determining if the user of the vehicle is in a sneezing episode. The sound associated with sneezing may vary based on the user of the vehicle, different sounds stored as data in a memory may be stored for different users of the vehicle. Alternatively, the sound could be different for different countries or regions, i.e. there may be language differences, and these may be accounted for by the system or the sounds stored. For example, in the United Kingdom or the United States of America the sound associated with sneezing may be “Achoo!”. The sound sensor may be able to utilise voice recognition signals generated based on or in response to the user's vocalisations. In addition to this, the sound sensor may be able to detect the verbal indicator from the user or passenger in the vehicle to indicate that the user is in a sneezing episode. In the event that the user knows they are sneezing, or a passenger of the vehicle notices that the user of the vehicle is in a sneezing episode, they can indicate this to the vehicle with a verbal indicator. The verbal indicator may be a pre-set verbal indicator, such as a word, which on detecting with the sound sensor the vehicle can automatically initiate the autonomous drive of the vehicle. The user may be able to set the word themselves, for example the user may be able to say or shout “sneeze” and the vehicle will initiate autonomous drive. There may be language differences or user voice differences between the verbal indicators by which the vehicle is informed that the user is in a sneezing episode. To avoid detecting sneezing by a passenger instead of the user, the direction and intensity of the sound can also be estimated by the audio sensor. Any sneezing sound not at the right angle and not in the expected intensity range is filtered by the sensor.

In addition to a camera taking an image of a user for processing, a motion sensor could detect movement of the user, which provides additional data for processing and determining if the user of the vehicle is in a sneezing episode.

The additional sensor could be a portable device located on the user, e.g. a smart phone, smart watch or some other device located on the user. These may be in communication with the vehicle, as part of the smart vehicle capabilities. The devices may be able to communicate additional data to the processor and/or the decision logic module as part of the determination of if the user is in the sneezing episode or not. For example, this additional data may be movement data (e.g. a smart watch may be able to detect movement of the user) or heart rate data (certain heart rate zones may be able to indicate or assist in the determination that the user is going to be entering a sneezing episode, this may be personalised for different users).

These additional sensor indicators may be more likely to detect a user being in a sneezing episode during or after the actual sneeze, however these may still be a useful detectors or indicators to the system for determining if the user is in a sneezing episode. As indicated above, in some embodiments, the method of determining if the user of vehicle is in a sneezing episode takes into account previous sneezing episodes e.g. in the same use period, thus these secondary detectors/indicators will also assist in any future decision making processes and may improve future sneezing episode prediction processes e.g. for the same vehicle use period. The positive confirmation to the system that the user is in a sneezing episode may also assist with generating data related to, for example, user movement associated with sneezing.

To avoid detecting sneezing by a passenger instead of the user, the sensors will be configured to detect only the relevant indicating factors from the driver, not the passenger.

Any one of the one or all of the above-mentioned factors can be taken into account by the decision logic module when determining if the user of the vehicle is in a sneezing episode.

FIG. 5 illustratively shows a simplified communication diagram for the method (500). This illustrates 4 sensors (a camera 502, a vapour sensor 504 a motion sensor 506 and a sound sensor 508) inputting data into a processor (510). The processor after processing the data then sends a signal to the decision logic module (512) and in this illustrative figure, the decision logic module after coming to a decision has the output of “yes/positive”, which here indicates that the user is in a user sneezing episode. This output is then communicated to a vehicle control device (514) and here this will result in the autonomous drive of the vehicle being initiated.

FIG. 6 illustratively shows the location of sensors in a car, an example of a system of an embodiment in a vehicle. This illustrates a dashboard camera (601) and another possible sensor (602) on the dashboard. This also illustrates a possible button (604) on the steering wheel which could be utilised for the user of the vehicle to be able to indicate that they are in or about to enter a sneezing episode. FIG. 6 also shows an example of a user display (606), which may display to the user information such as if the autonomous control of the vehicle has been initiated. This is just an illustrative embodiment, the autonomous control of the vehicle may be initiated without the user being aware, the user may be unaware of the sneezing episode monitoring or the presence of sensors and user display showing autonomous vehicle control.

For the detection or prediction of the user of the vehicle being in a sneezing episode, the detection or prediction may be improved based on the method being personalised to a specific user or based on data being collected and/or inputted for specific users. Personalised data for specific users, or specific user profiles, may be generated for the users of the vehicle. Data for each user may be collected or imputed into a memory and then used as part of the prediction and determination of if the user of the vehicle is in a sneezing episode. It can be understood that different people sneeze and act in different ways when they are in sneezing episodes. Data for each user collected or imputed could include the specific physical movements of the specific user associated with entering or being in a sneezing episode, for example which facial gestures of a specific user are associated with them entering or being in a sneezing episode. In the case of physical movements of the user, this could be for example in the form of historical images or data from images stored in a memory. Furthermore, specific user profiles may include data for factors such as the user having a medical condition likely to cause an increase in the number sneezing episodes experienced by the user. For example, the user may input to the system when they have a medical condition such as a cold, knowing that this is likely to increase the likelihood of them sneezing. The data related to this may then be stored for a set period of time and impact future determination of if the user is in the sneezing episode or not, based on an increased future likelihood of sneezing for a set period of time after having indicated they have a cold. It can be appreciated that the more a user uses a vehicle and the more data is collected about the specific user, the more improved the detection or prediction of the user being in a sneezing episode is. The specific data for users stored e.g. as part of specific user profiles may be taken into account when a decision logic module undergoes a decision process. It may be that for example different weightings are applied to different steps when the decision steps are taken, based on specific user data.

The vehicle may come with a pre-installed sneeze detection software and data already loaded. The user then has the option of training the detection/prediction algorithm when the vehicle goes into a training mode where the user sits on the seat and all the installed sensors are activated. The user can then configure the software to recognise a sneeze from the user. For example, the user can use some kind of sneeze spray to initiate the sneeze action so that the vehicle sensors are tuned to the specific user and the detection/prediction algorithm parameters are updated for a particular user. The factory settings can always be returned to by the vehicle computer. User profiles could be generated.

In some embodiments, the method may comprise the use of at least one biometric system capable of identifying a specific user from a biometric input. This may be how the vehicle has specific user data or profiles for specific users, and, for example, is able to improve the prediction or detection of if the user is in a sneezing episode or not, or know the level of autonomous drive control that the user wishes to have based on the detection or prediction of the user being in a sneezing episode. Biometric data may be generated from one or more sources including: cardiac (electrocardiogram (ECG)) signals generated based on or in response to the user's heartbeat; brain (electroencephalogram (EEG)) signals generated based on or in response to the user's brain activity; iris recognition signals generated based on or in response to scanning the user's iris; facial recognition signals generated based on or in response to analysing one or more of the user's facial features; voice recognition signals generated based on or in response to the user's vocalisations; chemical analysis signals generated based on or in response to analysing one or more of the user's bodily fluid(s), tissue(s) or scent(s) or fingerprint sensors on the steering wheel. It will be appreciated that the sources of biometric data provided above are exemplary only, and the biometric data may be generated from other sources. It will be appreciated that some of the sensors discussed in relation to detecting or predicting if the user of the vehicle is in a sneezing episode may be utilised for more than one function, e.g. a sound sensor may be used as part of voice recognition detection or a camera may be used as part of facial recognition software but also movement detection for determining if the user of the vehicle is in a sneezing episode or not.

Autonomous drive of the vehicle may be initiated, controlled and/or ended by a vehicle control device or circuit. In some embodiments the autonomous drive of the vehicle maintains the drive, course, direction of travel and speed of the vehicle as it was before the initiation of autonomous vehicle drive. In some embodiments the autonomous drive of the vehicle prevents the user of the vehicle from changing the drive, course, direction of travel, speed of the vehicle during the sneezing episode.

In some embodiments the autonomous drive of the vehicle slows the speed of the vehicle. In some embodiments, the autonomous drive of the vehicle moves the vehicle to the slow lane.

In some embodiments the autonomous drive of the vehicle takes control of the pedals, steering wheel and physical controls of the car.

In some embodiments, the ending the autonomous drive and reverting the drive of the vehicle back to the control of the user is done without the user of the vehicle being aware that there was autonomous drive of the vehicle.

In some embodiments, on detection or prediction that the user of the vehicle is in a sneezing episode, the time between the initiation of the autonomous drive and ending of the autonomous drive is for a pre-set time. In further embodiments, this pre-set time may be 0.5 seconds, 1 second, 1.5 seconds, 2 seconds, 2.5 seconds, 3 seconds, 3.5 seconds, 4 seconds, 5 seconds, 6 seconds, 7 seconds, 8 seconds, 9 seconds or 10 seconds, 11 seconds, 12 seconds, 13 seconds, 14 seconds, 15 seconds, 20 seconds or any such time interval suitable. In some further embodiments the user sets a pre-determined preference as to the length of time between the initiation of the autonomous drive and ending of the autonomous drive.

In some embodiments, the time between the initiation of the autonomous drive and ending of the autonomous drive is determined by the length of the sneezing episode. In some embodiments, the time between the initiation of the autonomous drive and ending of the autonomous drive is the length of the sneezing episode with an additional amount of time added onto the end of the length of the sneezing episode, for example the length of the sneezing episode plus 1 additional second. This pre-set amount of time added onto the end of the sneezing episode may be 0.5 seconds, 1 second, 1.5 seconds, 2 seconds, 2.5 seconds, 3 seconds, 3.5 seconds, 4 seconds, 5 seconds, 6 seconds, 7 seconds, 8 seconds, 9 seconds or 10 seconds.

It can be appreciated that the user of the vehicle may be able to specify the level, type or the length of the of autonomous control that they wish on there being a detection or prediction of the user of the vehicle is in a sneezing episode. It may be that different users have different preferences for the autonomous control level, based on their experiences of sneezing episodes. Some users may wish for full autonomous control, others may only wish for partial or for a very short period of time. Others may prefer autonomous control to take over for a long enough period of time for them to recover, different users will have different recovery times. The input of this may be on start-up of the vehicle by the user, or it may be predetermined as part of the factory settings, and/or it may be changed as part of the user interface with the autonomous car controls. The preferences for level of autonomous control may be stored as part of a user profile, as discussed previously in relation to specific user data.

In some embodiments the determining the end of the user sneezing episode is determined by using pre-set or pre-determined time, as described above in relation to the time between the initiation of the autonomous drive and ending of the autonomous drive is for a pre-set time; the same can apply. Alternatively, the determination of the end of the sneezing episode may be by determining the length of the user sneezing episode. The end of the user sneezing episode can be determined using the same methods for determining the beginning of the user sneezing episode. This can be with the same sensors and systems.

In some embodiments, the determining the end of the sneezing episode is by the user of the vehicle or a passenger in the vehicle indicating to the vehicle that the sneezing episode has ended. The user of the vehicle may be able to indicate to the vehicle that the sneezing episode has ended through, for example, by giving a verbal indicator to the vehicle or using a physical input to the vehicle that the user is no longer in a sneezing episode, or that the sneezing episode has ended. In some specific embodiments the user gives a physical input to the vehicle that the user is no longer in a sneezing episode, or that the sneezing episode has ended, for example the user pressing a button or using a switch or a dial which signals to end the autonomous drive of the vehicle. In some embodiments, the vehicle control remains under the control of the autonomous drive until the user indicates to the vehicle they wish to take back vehicle control or to end the autonomous vehicle control.

In some embodiments, the determining the end of the user sneezing episode is by at least one sensor detecting the user of the vehicle has ended the user sneezing episode. In some embodiments, the at least one sensor is the same sensor or sensor configuration which detected or predicted that the user of the vehicle is in a sneezing episode.

In addition to the method described, other techniques of the invention are outlined. These systems, computer program and vehicles are all capable of carrying, carrying out and/or enacting the methods of the invention outlined above. For the avoidance of doubt, particular embodiments of the method outlined are intended to be applied to the below techniques in addition to the method. All definitions of components and terms above also apply to the below techniques.

According to a further technique, there is provided a system of initiating autonomous drive of a vehicle when the vehicle is under the control of a user, the system comprising: a decision logic module for detecting or predicting the start of a user sneezing episode and a vehicle control circuit for initiating autonomous drive of the vehicle during the user sneezing episode. In some embodiments, the system further comprises a determination unit for determining the end of the user sneezing episode and an ending circuit for ending the autonomous drive of the vehicle and reverting the drive of the vehicle back to the control of the user. The decision logic module is capable of determining if the user of the vehicle is in a user sneezing episode in accordance with the definitions and embodiments of the methods outlined above.

FIG. 7 illustratively shows a simplified system (700) capable of initiating autonomous drive of a vehicle. 702 is a decision logic module for detecting or predicting the start of a user sneezing episode; 704 is a vehicle control circuit for initiating autonomous drive of the vehicle during the user sneezing episode and ending the autonomous drive of the vehicle, the symbol on 704 representing that it will communicate with the vehicle to control the autonomous drive of the vehicle; and 706 is a determination circuit for determining the end of the user sneezing episode. The arrows are merely representative, and all parts of the system are capable of communicating with each other if necessary.

FIG. 8 illustratively shows a second simplified system (800) capable of initiating autonomous drive of a vehicle. 702 is a decision logic module for detecting or predicting the start of a user sneezing episode; 704 is a vehicle control circuit for initiating autonomous drive of the vehicle during the user sneezing episode and ending the autonomous drive of the vehicle, the symbol on 704 indicating that it will communicate with the vehicle to control the autonomous drive of the vehicle; and 706 is determination circuit for determining the end of the user sneezing episode. 808 is a processor which can communicate with the decision logic module. This represents the input of data from e.g. a processor, which has captured data from the user which indicates that the user may be entering a user sneezing episode. It may be that the processor has processed an image taken from a camera and can then input that data into the decision logic module for a decision about if the user is in a sneezing episode or not). The data is captured from the user via a sensor (810). The arrow at 812 represents the input of data external from the system into the sensor. The arrows are merely representative, and all parts of the system are capable of communicating with each other if necessary.

In some embodiments, the system further comprises at least one sensor and a processor. In some further embodiments, the system the sensor is a camera capable of capturing at least one image of the user and the processor is capable of processing the newly captured at least one image. In some embodiments the sensor is capable of sensing a change in at least one physical movement of the user. In some embodiments, the at least one physical movement of the user is one associated with sneezing and is selected from the group consisting of: facial gestures associated with being in a user sneezing episode, the user covering their mouth, heavy breathing, a sharp intake of breath, eyes becoming smaller, head tilting backwards, head tilting forwards and repeated sniffing. In some further embodiments the facial gestures associated with being in a user sneezing episode are selected from the group consisting of: eyes partially shutting, eyes shutting, nostril size increasing, mouth opening and eyebrows raising.

In some embodiments the system also comprises a memory. This memory may store images related to the determining if the user of the vehicle is in a sneezing episode or not. In some embodiments, the processor is capable of comparing the newly captured at least one image of the user to at least one historical image of the user stored in a memory. In some further embodiments, this includes comparing the newly captured at least one image of the user to multiple historical images of the user from multiple historic time points stored in a memory. In some alternative embodiments, this includes comparing the newly captured at least one image of the user to multiple images stored in the memory, wherein the multiple images stored in the memory are images for generating a positive or negative match of the user being in a user sneezing episode or the user not being in a user sneezing episode, when compared with the newly captured at least one image of the user. The system may compare the newly captured at least one image of the user to multiple historical images of the user from multiple historic time points stored in a memory. In some embodiments the at least one or multiple historical image(s) of the user stored in a memory is an image or are images taken on the same day, in the same use session of the vehicle, or within the last one minute, a 1 minute period, a 5 minute period, a 10 minute period, a 20 minute period, a 30 minute period, a 40 minute period, a 50 minute period, a one hour period, a 2 hour period, a 3 hour period, a 4 hour period or a suitable time period whereby if the user has sneezed in that time period there is an increased likelihood that the user will enter a sneezing episode again. In some further embodiments, the system is capable of comparing the newly captured at least one image of the user to multiple images stored in the memory, wherein the multiple images stored in the memory are images for generating a positive or negative match of the user being in a sneezing episode or the user not being in a sneezing episode, when compared with the newly captured at least one image of the user. This may be that the processor carries out the comparing.

In some embodiments of the system the processor and/or the decision logic module and/or memory are located on-board the vehicle, in other embodiments the processor and/or the decision logic module and/or memory are located remote from the vehicle (e.g. in a cloud-based system). Both the processor and the decision logic module may be on-board the vehicle and able to communicate with each other as they are physically connected. The processor may transmit processed data to the decision logic module on-board the vehicle. When the processor and/or the decision logic module are remote, they may be part of a cloud-based storage, processing and/or decision logic network. There may be a service and/or database located on the cloud which the on-board camera, processors and/or decision logic module may be able to use. On-board processing or decision logic module decisions may be made partially on board and partially remote, for example partially in the cloud and partially on-board. The processor and the decision logic module may be one and the same, the same unit, where the processing and decision take place in the same unit or computer system.

FIG. 9 illustratively shows a simplified system (900) capable of initiating autonomous drive of a vehicle. This figure shows a processor (902) and a decision logic module (904) which are located as part of a representative cloud-based system or server (906) remote from a vehicle (908). The vehicle contains a system with other parts of the system (910) which could be for example a sensor and a vehicle control circuit.

In some embodiments, the decision logic module takes into account additional factors selected from the group consisting of: one or more medical conditions likely to cause an increase in the number sneezing episodes experienced by the user, the weather, outside pollen count, a sudden increase in sunlight intensity, the time of the year, particulate count in the air, and the number of sneezing episodes the user of the vehicle has had when previously using the vehicle on the same day. In some embodiments, the one or more medical conditions likely to cause increased sneezing episodes is selected from the group consisting of: an allergy, rhinitis, allergic rhinitis, hayfever, a cold, influenza, a viral respiratory infection, neurological condition, nasal polyps, a medical condition for which the user is taking medication, wherein the medication can cause an increase in sneezing episodes. The decision logic module can take into account such additional factors when determining if the user of the vehicle is in a sneezing episode. These factors may be stored in a memory or memory module in some embodiments.

In some embodiments, the decision logic module takes into account an input from the user to indicate that for a period of time there is an increased likelihood of them entering a sneezing episode. For example, the user may indicate their increased likelihood of them entering a sneezing episode due to any one of: the user having one or more medical conditions likely to cause an increase in the number sneezing episodes, the weather, outside pollen count, the time of the year, particulate count in the air, and the number of sneezing episodes the user of the vehicle has had when previously using the vehicle on the same day. This input may be stored in a memory module and may be stored over a period of time to build up data related to the sneezing determination process.

In some embodiments, the decision logic module takes into account the number of sneezing episodes the user has had in a given time period, wherein an increased number of sneezing episodes results in the decision logic module more likely to determine the user of the vehicle is in a sneezing episode. This can be over a specified period of time, the specified period of time may be within the last one minute, 5 minute period, 10 minute period, 20 minute period, 30 minute period, 40 minute period, 50 minute period, hour, 2 hours, 3 hours or 4 hours or suitable time period whereby if the user has sneezed in that time period there is an increased likelihood that the user will enter a sneezing episode again. The decision logic module may take this into account as part of the determining of if the user is in a user sneezing episode. This may be stored as part of a memory module in the system.

In some embodiments, the system comprises one or more additional sensors. In some further embodiments, the one or more additional sensors are selected from the following: a vapour or moisture sensor to detect vapour or moisture particles blown from the user; a piezo, air movement, air flow or pressure sensor to detect the intensity of air blown out by the user; a sound sensor to detect the user making a sound associated with being in a sneezing episode; or a motion sensor to detect movement of the user.

In some embodiments, the system may comprise a memory. The memory may contain personalised data for specific users, or specific user profiles; data or profiles may be generated for specific users of the vehicle Data for each user may be collected or imputed into a memory and then used as part of the prediction and determination of if the user of the vehicle is in a sneezing episode.

In some embodiments, the system may comprise a biometric system capable of identifying a specific user from a biometric input. For example, this may be how the vehicle has specific user data or profiles for specific users, and, for example, is able to improve the prediction or detection of if the user is in a sneezing episode or not, or to know the level of autonomous drive control that the user wishes to have based on the detection or prediction of the user being in a sneezing episode.

In some embodiments of the system, the sensor, processor and decision logic module determine if the user of the vehicle is in a user sneezing episode and also determine when the user sneezing episode is over.

In some embodiments of the system, the autonomous drive of the vehicle maintains the drive, course, direction of travel and speed of the vehicle as it was before the initiation of the vehicle control circuit to autonomously drive the vehicle during the sneezing episode. In some embodiments the autonomous drive of the vehicle prevents the user of the vehicle from changing the drive, course, direction of travel, speed of the vehicle during the sneezing episode.

In some embodiments of the system, the autonomous drive of the vehicle slows the speed of the vehicle. The drive may move the vehicle into a slow lane, or some other pre-determined suitable safer part of a road (i.e. a lay by or designated driver stopping point). In some embodiments of the system, the autonomous drive of the vehicle takes control of the pedals, steering wheel and physical controls of the car. In some embodiments of the system, the ending the autonomous drive and reverting the drive of the vehicle back to the control of the user is done without the user of the vehicle being aware that there was autonomous drive of the vehicle.

In some embodiments of the system, when the system detects or predicts that the user of the vehicle is in a sneezing episode, the time between the initiation of the autonomous drive and ending of the autonomous drive is for a pre-set time. In further embodiments, this pre-set time may be 0.5 seconds, 1 second, 1.5 seconds, 2 seconds, 2.5 seconds, 3 seconds, 3.5 seconds, 4 seconds, 5 seconds, 6 seconds, 7 seconds, 8 seconds, 9 seconds or 10 seconds, 11 seconds, 12 seconds, 13 seconds, 14 seconds, 15 seconds, 20 seconds or any such time interval suitable. In some further embodiments, the user can set a pre-determined preference as to the length of time between the initiation of the autonomous drive and ending of the autonomous drive.

In some embodiments of the system, the time between the initiation of the autonomous drive and the ending of the autonomous drive is determined by the length of the sneezing episode detected. In some embodiments, the time between the initiation of the autonomous drive and ending of the autonomous drive is the length of the sneezing episode with an additional amount of time added onto the end of the length of the sneezing episode, for example the length of the sneezing episode plus 1 additional second. This pre-set amount of time added onto the end of the sneezing episode may be 0.5 seconds, 1 second, 1.5 seconds, 2 seconds, 2.5 seconds, 3 seconds, 3.5 seconds, 4 seconds, 5 seconds, 6 seconds, 7 seconds, 8 seconds, 9 seconds or 10 seconds.

In some embodiments of the system, the determining of the end of the sneezing episode is by the user of the vehicle or a passenger in the vehicle indicating to the vehicle that the sneezing episode has ended. The user of the vehicle may be able to indicate to the vehicle that the sneezing episode has ended through, for example, by giving a verbal indicator to the vehicle or using a physical input to the vehicle that the user is no longer in a sneezing episode, or that the sneezing episode has ended. In some embodiments, the system comprises a button and/or a sound sensor with which the user or passenger of the vehicle can use to indicate to the system that the user of the vehicle is entering a sneezing episode. This allows the detection or prediction of the user of the vehicle being in a sneezing episode because the user of the vehicle or a passenger in the vehicle can indicate to the system or vehicle that the user is in a sneezing episode. In some further embodiments, the user of the vehicle or a passenger in the vehicle can indicated to the system that the user is in a sneezing episode by: giving a verbal indicator to the vehicle or using a physical input to the vehicle that the user is in a sneezing episode, and in some specific embodiments the physical input to the vehicle that the user is in a sneezing episode is the user or the passenger pressing a button or using a switch or a dial which signals to either the decision logic module or the vehicle control circuit to initiating autonomous drive of the vehicle. The ending unit and the vehicle control unit could be the same unit.

In some embodiments of the system, the system is capable of initiating autonomous drive of a vehicle without the user being aware of the autonomous drive of the vehicle.

According to a third technique, there is provided a computer program comprising a computer-readable storage medium storing computer program code operable, when loaded onto a computer and executed thereon, to cause said computer to control a method of initiating autonomous drive comprising: detecting or predicting the start of a user sneezing episode, initiating autonomous drive of the vehicle by a vehicle control circuit during the user sneezing episode, In some embodiments, the computer program also comprises code for determining the end of the user sneezing episode and ending the autonomous drive and reverting the drive of the vehicle back to the control of the user. According to a fourth technique of the invention, there is provided a computer program product able to cause said computer to control a method of initiating autonomous drive comprising any of the methods outlined above, in accordance with the first technique and embodiments thereof of the invention.

According to a fifth technique, there is provided a vehicle comprising electronic computer apparatus for initiating a method of autonomous drive when the vehicle is under the control of a user, the apparatus comprising a decision logic module for detecting or predicting the start of a user sneezing episode and a vehicle control circuit for initiating autonomous drive of the vehicle during the user sneezing. In some embodiments, the vehicle also comprises apparatus comprising determination logic for determining the end of the user sneezing episode; and ending logic for ending the autonomous drive of the vehicle and reverting the drive of the vehicle back to the control of the user. According to a sixth technique of the invention, there is provided a vehicle comprising electronic computer apparatus for initiating any of the methods outlined above, in accordance with the first technique and embodiments thereof of the invention.

As will be appreciated by one skilled in the art, the present techniques may be embodied as a system, method, vehicle or computer program. Accordingly, the present techniques may take the form of an entirely hardware embodiment, an entirely software embodiment, or an embodiment combining software and hardware.

Furthermore, the present techniques may take the form of a computer program embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to particular embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, an embodiment of the present techniques may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present techniques.

Embodiments of the present techniques provide a non-transitory data carrier carrying code which, when implemented on a processor, causes the processor to carry out the methods described herein.

The techniques further provide processor control code to implement the above-described methods, for example on a general-purpose computer system or on a digital signal processor (DSP). The techniques also provide a carrier carrying processor control code to, when running, implement any of the above methods, in particular on a non-transitory data carrier or on a non-transitory computer-readable medium such as a disk, microprocessor, CD- or DVD-ROM, programmed memory such as read-only memory (firmware), or on a data carrier such as an optical or electrical signal carrier. The code may be provided on a (non-transitory) carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

Computer program code for carrying out operations for the above-described techniques may be written in any combination of one or more programming languages, including object-oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to particular embodiments of the present techniques may suitably be embodied in a logic apparatus comprising logic elements to perform the steps of the above-described methods, and that such logic elements may comprise components such as logic gates in, for example a programmable logic array or application-specific integrated circuit or programmable processors. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

It will be understood that, although the terms first, second, etc. may be used herein to describe various features, these features should not be limited by these terms. These terms are only used to distinguish one feature from another. Furthermore, the term “and/or” includes any and all combinations of one or more of the associated listed items.

Furthermore, the terminology used herein is for the purpose of describing embodiments only and is not intended to be limiting. For example, as used herein the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In the preceding description, various embodiments of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

The techniques described herein can be summarised in the following clauses:

1) A computer implemented method of initiating autonomous drive of a vehicle when the drive of the vehicle is under the control of a user, the method comprising: detecting or predicting the start of a user sneezing episode; and initiating autonomous drive of the vehicle during the user sneezing episode.
2) The method of clause 1, wherein after the initiating the autonomous drive of the vehicle, the method includes determining the end of the user sneezing episode, ending the autonomous drive of the vehicle and reverting the drive of the vehicle back to the control of the user.
3) The method of clause 1 or clause 2, the user of the vehicle being unaware of the autonomous drive of the vehicle.
4) The method according to any one of clauses 1 to 3, including: capturing at least one image of the user; processing the newly captured at least one image; and determining if the user of the vehicle is in a user sneezing episode.
5) The method according to clause 4, including sensing a change in at least one physical movement of the user, wherein the at least one physical movement of the user is one associated with sneezing and is selected from the group consisting of: facial gestures associated with being in a user sneezing episode, the user covering their mouth, heavy breathing, a sharp intake of breath, head tilting backwards, head tilting forwards, eyes becoming smaller and repeated sniffing.
6) The method according to clause 5, wherein the facial gestures associated with being in a user sneezing episode are selected from the group consisting of: eyes partially shutting, eyes shutting, nostril size increasing, mouth opening and eyebrows raising.
7) The method according to any one of clauses 4 to 6, including comparing the newly captured at least one image of the user to at least one historical image of the user stored in a memory.
8) The method according to clause 7, including comparing the newly captured at least one image of the user to multiple historical images of the user from multiple historic time points stored in a memory.
9) The method according to clause 7, including comparing the newly captured at least one image of the user to multiple images stored in the memory, wherein the multiple images stored in the memory are images suitable for generating a positive or negative match of the user being in a user sneezing episode or the user not being in a user sneezing episode, when compared with the newly captured at least one image of the user.
10) The method according to any one of clauses 4 to 9, wherein there are multiple determinations of if the user of the vehicle is in a user sneezing episode during a user sneezing episode, wherein the later determinations take into account the earlier determinations, so as to improve the accuracy of the decision making process as time progresses throughout a sneezing episode.
11) The method according to any one of clauses 4 to 10, wherein the processing occurs in a computer on-board the vehicle.
12) The method according to any one of clauses 4 to 10, wherein the processing occurs in a computer located remote from the vehicle.
13) The method according to any one of clauses 4 to 12, wherein determining takes into account additional factors selected from the group consisting of: a medical condition likely to cause an increase in the number sneezing episodes experienced by the user, the weather, outside pollen count, a sudden increase in sunlight intensity, the time of the year, particulate count in the air, and the number of sneezing episodes the user of the vehicle has had when previously using the vehicle on the same day.
14) The method according to any one of clauses 4 to 13, wherein the determining takes into account an input from the user to indicate that for a period of time there is an increased likelihood them entering a user sneezing episode.
15) The method according to clause 14, wherein the increased likelihood of the user entering a user sneezing episode is because the user has at least one medical condition likely to cause an increased number of user sneezing episodes.
16) The method according to clause 14, wherein the determining takes into account the number of user sneezing episodes the user has had in a given time period, wherein an increased number of user sneezing episodes results in an increased likelihood of determining the user of the vehicle is in a user sneezing episode.
17) The method according to any one of clauses 1, 2, 4 to 9, 11 or 12, wherein the detecting or predicting of the user of the vehicle being in a user sneezing episode is because the user of the vehicle or a passenger in the vehicle has indicated to the vehicle that the user is in a user sneezing episode.
18) The method according to clause 17, wherein the user of the vehicle or a passenger in the vehicle has indicated to the vehicle that the user is in a user sneezing episode by: giving a verbal indicator to the vehicle or physically indicating that the user is in a user sneezing episode.
19) The method according to any one of clauses 4 to 18, wherein the detecting or predicting the user of the vehicle is in a user sneezing episode comprises the use of (at least one additional) sensing method for detecting or predicting the user of the vehicle is in a user sneezing episode, wherein the (at least one additional) sensing method is one or more of the following: vapour or moisture sensing to detect vapour or moisture particles blown from the user; piezo, air movement, air flow or pressure sensing to detect the intensity of air blown out by the user; sound sensing detecting the user making a sound associated with being in a user sneezing episode; or motion sensing to detect movement of the user.
20) The method according to any one of clauses 1 to 19, wherein the autonomous drive of the vehicle maintains the drive, course, direction of travel and speed of the vehicle as it was before the initiation of autonomous vehicle drive.
21) The method according to any one of clauses 1 to 19, wherein the autonomous drive of the vehicle prevents the user of the vehicle from changing the drive, course, direction of travel, speed of the vehicle during the user sneezing episode.
22) The method according to any one of clauses 1 to 19, wherein the autonomous drive of the vehicle slows the speed of the vehicle or wherein the autonomous drive of the vehicle moves the vehicle to the slow lane.
23) The method according to any one of clauses 1, 2 or 4 to 22, wherein ending the autonomous drive and reverting the drive of the vehicle back to the control of the user is done without the user of the vehicle being aware that there was autonomous drive of the vehicle.
24) The method according to any one of clauses 1 to 23, wherein the time between the initiation of the autonomous drive and ending of the autonomous drive is a pre-set time.
25) The method according to clauses 1, 2 or 4 to 22, wherein the determining the end of the user sneezing episode is by the user of the vehicle or a passenger in the vehicle indicating to the vehicle that the user sneezing episode has ended.
26) The method according to any one of clauses 1 to 23, wherein the determining the end of the user sneezing episode is by at least one sensor detecting the user of the vehicle has ended the user sneezing episode.
27) The method according to clause 26, wherein the at least one sensor is the same sensor or sensor configuration which detected or predicted that the user of the vehicle is in a sneezing episode.
28) A system of initiating autonomous drive of a vehicle when the vehicle is under the control of a user, the system comprising: a decision logic module for detecting or predicting the start of a user sneezing episode; and a vehicle control unit for initiating autonomous drive of the vehicle during the user sneezing episode.
29) The system of clause 28, the system further comprising: a determination unit for determining the end of the user sneezing episode; and an ending unit for ending the autonomous drive of the vehicle and reverting the drive of the vehicle back to the control of the user.
30) The system of clause 29, wherein the ending unit and the vehicle control unit are the same unit.
31) The system of clause 28, wherein the system further comprises at least one sensor and a processor.
32) The system of clause 31, wherein the at least one sensor is a camera capable of capturing at least one image of the user and the processor is capable of processing the newly captured at least one image.
33) The system of clause 31, wherein both the processor and decision logic module are located on-board the vehicle.
34) The system of clause 31, wherein both the processor and decision logic module are located remote from the vehicle.
35) The system of any one of clauses 31 to 34, wherein the system comprises one or more additional sensor.
36) The system of clause 35, wherein the one or more additional sensor is at least one sensor selected from the following: a vapour or moisture sensor to detect vapour or moisture particles blown from the user; a piezo, air movement, air flow or pressure sensor to detect the intensity of air blown out by the user; a sound sensor to detect the user making a sound associated with being in a sneezing episode; or a motion sensor to detect movement of the user.
37) The system of clause any one of clauses 31 to 36, wherein the at least one sensor, processor and decision logic module determine if the user of the vehicle is in a user sneezing episode and also when the user sneezing episode is over.
38) The system according to any one of clauses 28 to 37, wherein the system is capable of initiating autonomous drive of a vehicle without the user being aware of the autonomous drive of the vehicle.
39) The system according to any one of clauses 28 to 37, wherein the system further comprises a button or sound sensor with which the user or passenger of the vehicle can use to indicate that the user of the vehicle is entering a sneezing episode.
40) A computer program comprising a computer-readable storage medium storing computer program code operable, when loaded onto a computer and executed thereon, to cause said computer to control a method of initiating autonomous drive comprising: detecting or predicting the start of a user sneezing episode; and initiating autonomous drive of the vehicle during the user sneezing episode.
41) A vehicle comprising electronic computer apparatus for initiating a method of autonomous drive when the vehicle is under the control of a user, the apparatus comprising a decision logic module for detecting or predicting the start of a user sneezing episode and a vehicle control circuit for initiating autonomous drive of the vehicle during the user sneezing.
42) A system of initiating autonomous drive of a vehicle when the vehicle is under the control of a user, the system capable of carrying out the method of any one of clauses 1 to 27.
43) A computer program comprising a computer-readable storage medium storing computer program code operable, when loaded onto a computer and executed thereon, to cause said computer to control a method of initiating autonomous drive comprising, where the method is the method of any one of clauses 1 to 27.
44) A vehicle capable of carrying out the method of any one of clauses 1 to 27.

1. A method of initiating an autonomous drive of a vehicle when the drive of the vehicle is under the control of a user, the method comprising:
detecting or predicting the start of a user sneezing episode; and
initiating the autonomous drive of the vehicle during the user sneezing episode, wherein the user of the vehicle is unaware of the autonomous drive of the vehicle.

2. The method of claim 1, further comprising:
determining the end of the user sneezing episode;
ending the autonomous drive of the vehicle; and
reverting the drive of the vehicle back to the control of the user.

3. (canceled)

4. The method of claim 1, wherein detecting or predicting the start of the user sneezing episode comprises:
capturing at least one image of the user;
processing the captured at least one image; and
determining if the user of the vehicle is in the user sneezing episode.

5. The method of claim 4, wherein detecting or predicting the start of the user sneezing episode further comprises sensing a change in at least one physical movement of the user, wherein the at least one physical movement of the user is associated with sneezing, and wherein the at least one physical movement comprises facial gestures associated with being in a user sneezing episode, the user covering their mouth, heavy breathing, a sharp intake of breath, head tilting backwards, head tilting forwards, eyes becoming smaller, repeated sniffing, or combinations thereof.

6. The method of claim 4, wherein detecting or predicting the start of the user sneezing episode further comprises comparing the captured at least one image of the user to at least one historical image of the user stored in a memory.

7. The method of claim 4, wherein there are multiple determinations of if the user of the vehicle is in a user sneezing episode during a user sneezing episode, wherein later determinations of the multiple determinations take into account earlier determinations of the multiple determinations, so as to improve the accuracy of the decision making process as time progresses throughout a sneezing episode.

8. The method of claim 4, wherein the determining takes into account additional factors, wherein the additional factors comprise: a medical condition likely to cause an increase in the number of sneezing episodes experienced by the user, the weather, outside pollen count, a sudden increase in sunlight intensity, the time of the year, particulate count in the air, the number of sneezing episodes the user of the vehicle has had when previously using the vehicle on the same day, or combinations thereof.

9. The method of claim 4, wherein the determining takes into account an input from the user indicating that for a period of time there is an increased likelihood of the user entering the user sneezing episode.

10. The method of claim 4, wherein the determining takes into account the number of user sneezing episodes the user has had in a given time period, wherein an increased number of user sneezing episodes results in an increased likelihood of determining the user of the vehicle is in a user sneezing episode.

11. The method of claim 1, wherein the detecting or predicting of the user of the vehicle being in the user sneezing episode is based on an input from the user of the vehicle or a passenger in the vehicle indicating that the user is in a user sneezing episode.

12. The method of claim 4, wherein the detecting or predicting the user of the vehicle is in a user sneezing episode is based on the use of a sensing method for detecting or predicting the user of the vehicle is in a user sneezing episode, wherein the sensing method is one or more of the following:
vapour or moisture sensing to detect vapour or moisture particles blown from the user;
piezo, air movement, air flow or pressure sensing to detect the intensity of air blown out by the user;
sound sensing detecting the user making a sound associated with being in a user sneezing episode;
motion sensing to detect movement of the user; or
combinations thereof.

13. The method of claim 1, wherein the autonomous drive of the vehicle is configured to:
maintain the drive, course, direction of travel, speed, or combinations thereof of the vehicle as it was before the initiation of the autonomous drive;
prevent the user of the vehicle from changing the drive, course, direction of travel, speed, or combinations thereof of the vehicle during the user sneezing episode;
slow the speed of the vehicle; or
move the vehicle to the slow lane; or
combinations thereof.

14. The method of claim 1, further comprising ending the autonomous drive and reverting the drive of the vehicle back to the control of the user is done without the user of the vehicle being aware that there was autonomous drive of the vehicle.

15. The method of claim 1, further comprising determining the end of the user sneezing episode based on an input from the user of the vehicle or a passenger in the vehicle indicating to the vehicle that the user sneezing episode has ended.

16. The method of claim 1, further comprising determining the end of the user sneezing episode based on at least one sensor detecting the user of the vehicle has ended the user sneezing episode.

17. A system of initiating an autonomous drive of a vehicle when the vehicle is under the control of a user, the system comprising:
a processor; and
a memory comprising a plurality of program instructions which, when executed by the processor, cause the processor to:
detect or predict the start of a user sneezing episode; and
initiate the autonomous drive of the vehicle during the user sneezing episode, wherein the user of the vehicle is unaware of the autonomous drive of the vehicle.

18. The system of claim 17, wherein the plurality of program instructions which, when executed by the processor, further cause the processor to:
determine the end of the user sneezing episode; and
end the autonomous drive of the vehicle and revert the drive of the vehicle back to the control of the user.

19. A computer program comprising a non-transitory computer-readable storage medium storing computer program code operable, when loaded onto a computer and executed thereon, to cause said computer to control a method of initiating an autonomous drive of a vehicle when the drive of the vehicle is under the control of a user comprising:
detecting or predicting the start of a user sneezing episode; and
initiating the autonomous drive of the vehicle during the user sneezing episode, wherein the user of the vehicle is unaware of the autonomous drive of the vehicle.

20. A vehicle, comprising an electronic computer apparatus for initiating a method of autonomous drive when the vehicle is under the control of a user, the apparatus comprising:
a processor; and
a memory comprising a plurality of program instructions which, when executed by the processor, cause the processor to:
detect or predict the start of a user sneezing episode; and
initiate the autonomous drive of the vehicle during the user sneezing episode, wherein the user of the vehicle is unaware of the autonomous drive of the vehicle.
